(19) United States
(12) Patent Application Publication
(10) Pub. No.: US 2009/0014685 A1
(43) Pub. Date: Jan. 15, 2009

(54) LUMINESCENT MATERIAL USING (Y, GD)-CONTAINING NANOPARTICLE AND SURFACE BOUND ORGANTIC LIGANDS

(75) Inventors: Thomas Justel, Witten (DE); Joachim Opitz, Aachen (DE); Petra Huppertz, Roetgen (DE); Detlef Uwe Wiechert, Alsdorf (DE); Helga Bettentrup, Steinfurt (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/281,159

(22) PCT Filed: Feb. 22, 2007
(86) PCT No.: PCT/IB07/50565

§ 371 Date: Aug. 29, 2008

(30) Foreign Application Priority Data
Mar. 6, 2006 (EP) 06110694.4

(51) Int. Cl. C07F 19/00; C09K 11/06; B32B 3/02

(52) U.S. Cl. 252/301.16; 428/402; 534/15

(57) ABSTRACT

The invention relates to a luminescent material for an light emitting device comprising an (YGd)-containing nanoparticle material linked to at least one organic ligand molecule

The present invention is directed to luminescent materials, especially to the field of converter materials for fluorescent light sources, especially LEDs

For phosphor converted LEDs (pcLEDs) there is a need that the excitation and emission spectrum of the applied phosphors are adapted to the emission spectrum of the semiconductor and to the aimed applications wherein the LEDs are intended to be used. However, especially in the field of red emitting phosphors based on the activator Eu³⁺, such an adaption can only be achieved with great difficulty since there are only few measures to shift the absorption edge of an Eu³⁺ phosphor into the visible range.

It is an object of the present invention to provide a luminescent material for pcLEDs, which can be adapted to various emission wavelength of the semiconductor and application areas of the pcLED.

This object is solved by a luminescent material according to claim 1 of the present invention. Accordingly, a luminescent material is provided comprising an (Y,Gd)-containing nanoparticle material, which surface is linked to at least one organic ligand molecule.

By doing so, for most applications at least one of the following advantages can be achieved:
Higher photoluminescence efficiency
Stronger absorption
Absorption in the near UV and blue spectral range (for selected organic ligands)

The term “linked” means, describes and/or includes that the nanoparticle material and the at least one organic molecule are bonded to each other via covalent bonds, electrostatic bonds, hydrogen bonds, complex bonds (e.g. coordinative metal complex bonds) and/or any other suitable bonds and/or forces.

According to an embodiment of the present invention, the d₅₀ size of the (Y,Gd)-containing nanoparticle material is ≧2 nm to ≦100 nm.

According to an embodiment of the present invention, the d₅₀ size of the (Y,Gd)-containing nanoparticle material is ≧4 nm to ≦50 nm.

According to an embodiment of the present invention, the d₅₀ size of the (Y,Gd)-containing nanoparticle material is ≧5 nm to ≦20 nm.

According to an embodiment of the present invention, the (Y,Gd)-containing nanoparticle material is a (Y,Gd)-oxide material.

According to an embodiment of the present invention, the (Y,Gd)-containing nanoparticle material is selected out of the group comprising (Y₁₋ₓGdₓ)BO₃, (Y₁₋ₓGdₓ)₂O₃, (Y₁₋ₓGdₓ)VO₄, (Y₁₋ₓGdₓ)NbO₄, (Y₁₋ₓGdₓ)₂O₂S, (Y₁₋ₓGdₓ)₃Al₅O₁₂, (Y₁₋ₓGdₓ)₂SiO₅, (Y₁₋ₓGdₓ)PO₄ and mixtures thereof.

According to an embodiment of the present invention, the (Y,Gd)-containing nanoparticle material is doped with at least one trivalent dopant material.

According to an embodiment of the present invention, the (Y,Gd)-containing nanoparticle material is doped with at least one dopant material selected out of the group La, Ce, Pr, Nd, Pm, Sm, Eu, Gd, Tb, Dy, Ho, Er, Tm, Yb, Lu.

According to an embodiment of the present invention, at least one of the dopant material(s) serves as an activator material which is capable of emitting light.

According to an embodiment of the present invention, the dotation level of the dopant material in the (Y,Gd)-containing nanoparticle material is ≧0.5 mol-% to ≦50%.

According to an embodiment of the present invention, the dotation level of the dopant material in the (Y,Gd)-containing nanoparticle material is ≧1% to ≦25%.

According to an embodiment of the present invention, the dotation level of the dopant material in the (Y,Gd)-containing nanoparticle material is ≧2% to ≦10%.

According to an embodiment of the present invention, the at least one organic ligand molecule is a multidentate and/or chelate material.

According to an embodiment of the present invention, the at least one organic ligand molecule is a N and/or O-donor molecule.

According to an embodiment of the present invention, the at least one organic ligand molecule absorbs in the region of ≧300 nm to ≦500 nm.

According to an embodiment of the present invention, the at least one organic ligand molecule absorbs in the region of ≧320 nm to ≦480 nm.

According to an embodiment of the present invention, the at least one organic ligand molecule absorbs in the region of ≧350 nm to ≦450 nm.

According to an embodiment of the present invention, the at least one organic ligand molecule has a triplet state which is ≧3000 cm⁻¹ to ≦13000 cm⁻¹ above the light emitting state of the light emitting material(s) in the (Y,Gd)-containing nanoparticle material.

According to an embodiment of the present invention, the at least one organic ligand molecule has a triplet state which is ≧4000 cm⁻¹ to ≦10000 cm⁻¹ above the light emitting state of the light emitting material(s) in the (Y,Gd)-containing nanoparticle material.

According to an embodiment of the present invention, the at least one organic ligand molecule has a triplet state which is ≧20000 cm⁻¹ to ≦50000 cm⁻¹ above the ground state of the light emitting material(s) in the (Y,Gd)-containing nanoparticle material.

According to an embodiment of the present invention, the at least one organic ligand molecule has a triplet state which is ≧25000 cm⁻¹ to ≦45000 cm⁻¹ above the light emitting state of the light emitting material(s) in the (Y,Gd)-containing nanoparticle material.

According to an embodiment of the present invention, the at least one organic ligand molecule has a triplet state which is ≧30000 cm⁻¹ to ≦40000 cm⁻¹ above the light emitting state of the light emitting material(s) in the (Y,Gd)-containing nanoparticle material.

According to an embodiment of the present invention, the ratio of organic ligand molecule(s) to the light emitting material(s) in the (Y,Gd)-containing nanoparticle material is ≧0.01:1 to ≦0.9:1.

According to an embodiment of the present invention, the ratio of organic ligand molecule(s) to the light emitting material(s) in the (Y,Gd)-containing nanoparticle material is ≧0.1:1 to ≦0. 5:1

According to an embodiment of the present invention, at least one of the organic ligand molecule(s) has the following structure I

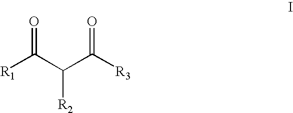

whereby R₁, R₂ and/or R₃ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

Generic group definition: Throughout the description and claims generic groups have been used, for example alkyl, alkoxy, aryl. Unless otherwise specified the following are preferred groups that may be applied to generic groups found within compounds disclosed herein:

alkyl: linear and branched C1-C8-alkyl,

long-chain alkyl: linear and branched C5-C20 alkyl

alkenyl: C2-C6-alkenyl,

cycloalkyl: C3-C8-cycloalkyl,

alkoxy: C1-C6-alkoxy,

long-chain alkoxy: linear and branched C5-C20 alkoxy

alkylene: selected from the group consisting of:

methylene; 1,1-ethylene; 1,2-ethylene; 1,1-propylidene; 1,2-propylene; 1,3-propylene; 2,2-propylidene; butan-2-ol-1,4-diyl; propan-2-ol-1,3-diyl; 1,4-butylene; cyclohexane-1,1-diyl; cyclohexan-1,2-diyl; cyclohexan-1,3-diyl; cyclohexan-1,4-diyl; cyclopentane-1,1-diyl; cyclopentan-1,2-diyl; and cyclopentan-1,3-diyl,

aryl: selected from homoaromatic compounds having a molecular weight under 300,

arylene: selected from the group consisting of: 1,2-phenylene; 1,3-phenylene; 1,4-phenylene; 1,2-naphtalenylene; 1,3-naphtalenylene; 1,4-naphtalenylene; 2,3-naphtalenylene; 1-hydroxy-2,3-phenylene; 1-hydroxy-2,4-phenylene; 1-hydroxy-2,5-phenylene; and 1-hydroxy-2,6-phenylene,

heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; thenoyl, oxazolidinyl; pyrrolyl; carbazolyl; indolyl; and isoindolyl, wherein the heteroaryl may be connected to the compound via any atom in the ring of the selected heteroaryl,

heteroarylene: selected from the group consisting of: pyridindiyl; quinolindiyl; pyrazodiyl; pyrazoldiyl; triazolediyl; pyrazindiyl; and imidazolediyl, wherein the heteroarylene acts as a bridge in the compound via any atom in the ring of the selected heteroarylene, more specifically preferred are: pyridin-2,3-diyl; pyridin-2,4-diyl; pyridin-2,5-diyl; pyridin-2,6-diyl; pyridin-3,4-diyl; pyridin-3,5-diyl; quinolin-2,3-diyl; quinolin-2,4-diyl; quinolin-2,8-diyl; isoquinolin-1,3-diyl; isoquinolin-1,4-diyl; pyrazol-1,3-diyl; pyrazol-3,5-diyl; triazole-3,5-diyl; triazole-1,3-diyl; pyrazin-2,5-diyl; and imidazole-2,4-diyl, a -C1-C6-heterocycloalkyl, wherein the heterocycloalkyl of the -C1-C6-heterocycloalkyl is, selected from the group consisting of: piperidinyl; piperidine; 1,4-piperazine, tetrahydrothiophene; tetrahydrofuran; 1,4,7-triazacyclononane; 1,4,8,11-tetraazacyclotetradecane; 1,4,7,10,13-pentaazacyclopentadecane; 1,4-diaza-7-thia-cyclononane; 1,4-diaza-7-oxa-cyclononane; 1,4,7,10-tetraazacyclododecane; 1,4-dioxane; 1,4,7-trithia-cyclononane; pyrrolidine; and tetrahydropyran, wherein the heterocycloalkyl may be connected to the -C1-C6-alkyl via any atom in the ring of the selected heterocycloalkyl,

heterocycloalkylene: selected from the group consisting of: piperidin-1,2-ylene; piperidin-2,6-ylene; piperidin-4,4-ylidene; 1,4-piperazin-1,4-ylene; 1,4-piperazin-2,3-ylene; 1,4-piperazin-2,5-ylene; 1,4-piperazin-2,6-ylene; 1,4-piperazin-1,2-ylene; 1,4-piperazin-1,3-ylene; 1,4-piperazin-1,4-ylene; tetrahydrothiophen-2,5-ylene; tetrahydrothiophen-3,4-ylene; tetrahydrothiophen-2,3-ylene; tetrahydrofuran-2,5-ylene; tetrahydrofuran-3,4-ylene; tetrahydrofuran-2,3-ylene; pyrrolidin-2,5-ylene; pyrrolidin-3,4-ylene; pyrrolidin-2,3-ylene; pyrrolidin-1,2-ylene; pyrrolidin-1,3-ylene; pyrrolidin-2,2-ylidene; 1,4,7-triazacyclonon-1,4-ylene; 1,4,7-triazacyclonon-2,3-ylene; 1,4,7-triazacyclonon-2,9-ylene; 1,4,7-triazacyclonon-3,8-ylene; 1,4,7-triazacyclonon-2,2-ylidene; 1,4,8,11-tetraazacyclotetradec-1,4-ylene; 1,4,8,11-tetraazacyclotetradec-1,8-ylene; 1,4,8,11-tetraazacyclotetradec-2,3-ylene; 1,4,8,11-tetraazacyclotetradec-2,5-ylene; 1,4,8,11-tetraazacyclotetradec-1,2-ylene; 1,4,8,11-tetraazacyclotetradec-2,2-ylidene; 1,4,7,10-tetraazacyclododec-1,4-ylene; 1,4,7,10-tetraazacyclododec-1,7-ylene; 1,4,7,10-tetraazacyclododec-1,2-ylene; 1,4,7,10-tetraazacyclododec-2,3-ylene; 1,4,7,10-tetraazacyclododec-2,2-ylidene; 1,4,7,10,13 pentaazacyclopentadec-1,4-ylene; 1,4,7,10,13-pentaazacyclopentadec-1,7-ylene; 1,4,7,10,13-pentaazacyclopentadec-2,3-ylene; 1,4,7,10,13-pentaazacyclopentadec-1,2-ylene; 1,4,7,10,13-pentaazacyclopentadec-2,2-ylidene; 1,4-diaza-7-thia-cyclonon-1,4-ylene; 1,4-diaza-7-thia-cyclonon-1,2-ylene; 1,4-diaza-7thia-cyclonon-2,3-ylene; 1,4-diaza-7-thia-cyclonon-6,8-ylene; 1,4-diaza-7-thia-cyclonon-2,2-ylidene; 1,4-diaza-7-oxacyclonon-1,4-ylene; 1,4-diaza-7-oxa-cyclonon-1,2-ylene; 1,4diaza-7-oxa-cyclonon-2,3-ylene; 1,4-diaza-7-oxa-cyclonon-6,8-ylene; 1,4-diaza-7-oxa-cyclonon-2,2-ylidene; 1,4-dioxan-2,3-ylene; 1,4-dioxan-2,6-ylene; 1,4-dioxan-2,2-ylidene; tetrahydropyran-2,3-ylene; tetrahydropyran-2,6-ylene; tetrahydropyran-2,5-ylene; tetrahydropyran-2,2-ylidene; 1,4,7-trithia-cyclonon-2,3-ylene; 1,4,7-trithia-cyclonon-2,9-ylene; and 1,4,7-trithia-cyclonon-2,2-ylidene,

heterocycloalkyl: selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thiacyclononanyl; 1,4-diaza-7-oxa-cyclononanyl; 1,4,7,10-tetraazacyclododecanyl; 1,4-dioxanyl; 1,4,7-trithiacyclononanyl; tetrahydropyranyl; and oxazolidinyl, wherein the heterocycloalkyl may be connected to the compound via any atom in the ring of the selected heterocycloalkyl,

amine: the group —N(R)2 wherein each R is independently selected from: hydrogen; C1-C6-alkyl; C1-C6-alkyl-C6H5; and phenyl, wherein when both R are C1-C6-alkyl both R together may form an —NC3 to an —NC5 heterocyclic ring with any remaining alkyl chain forming an alkyl substituent to the heterocyclic ring,

halogen: selected from the group consisting of: F; Cl; Br and I,

halogenalkyl: selected from the group consisting of mono, di, tri-, poly and perhalogenated linear and branched C1-C8-alkyl

pseudohalogen: selected from the group consisting of —CN, —SCN, —OCN, N₃, —CNO, —SeCN

sulphonate: the group —S(O)₂OR, wherein R is selected from: hydrogen; C1-C6-alkyl; phenyl; C1-C6-alkyl-C6H5; Li; Na; K; Cs; Mg; and Ca,

sulphate: the group —OS(O)₂OR, wherein R is selected from: hydrogen; C1-C6-alkyl; phenyl; C1-C6-alkyl-C6H5; Li; Na; K; Cs; Mg; and Ca,

sulphone: the group —S(O)₂R, wherein R is selected from: hydrogen; C1-C6-alkyl; phenyl; C1-C6-alkyl-C6H5 and amine (to give sulphonamide) selected from the group: —NR′2, wherein each R′ is independently selected from: hydrogen; C1-C6-alkyl; C1C6-alkyl-C6H5; and phenyl, wherein when both R′ are C1-C6-alkyl both R′ together may form an —NC3 to an —NCS heterocyclic ring with any remaining alkyl chain forming an alkyl substituent to the heterocyclic ring,

carboxylate derivative: the group —C(O)OR, wherein R is selected from: hydrogen; C1-C6-alkyl; phenyl; C1-C6-alkyl-C6H5; Li; Na; K; Cs; Mg; and Ca,

carbonyl derivative: the group —C(O)R, wherein R is selected from: hydrogen; C1-C6-alkyl; phenyl; C1-C6-alkyl-C6H5 and amine (to give amide) selected from the group: —NR′2, wherein each R′ is independently selected from: hydrogen; C1-C6-alkyl; C1-C6-alkyl-C6H5; and phenyl, wherein when both R′ are C1-C6-alkyl both R′ together may form an —NC3 to an —NC5 heterocyclic ring with any remaining alkyl chain forming an alkyl substituent to the heterocyclic ring,

phosphonate: the group —P(O) (OR) 2, wherein each R is independently selected from: hydrogen; C1-C6-alkyl; phenyl; C1-C6-alkyl-C6H5; Li; Na; K; Cs; Mg; and Ca,

phosphate: the group —OP(O)(OR)2, wherein each R is independently selected from: hydrogen; C1-C6-alkyl; phenyl; C1-C6-alkyl-C6H5; Li; Na; K; Cs; Mg; and Ca,

phosphine: the group —P(R)2, wherein each R is independently selected from: hydrogen; C1-C6-alkyl; phenyl; and C1-C6-alkyl-C6H5,

phosphine oxide: the group —P (O) R2, wherein R is independently selected from: hydrogen; C1-C6-alkyl; phenyl; and C1-C6-alkyl-C6H5; and amine (to give phosphonamidate) selected from the group: —NR′2, wherein each R′ is independently selected from: hydrogen; C1-C6-alkyl; C1-C6-alkyl-C6H5; and phenyl, wherein when both R′ are C1-C6-alkyl both R′ together may form an —NC3 to an —NC5 heterocyclic ring with any remaining alkyl chain forming an alkyl substituent to the heterocyclic ring.

polyether: chosen from the group comprising —(O—CH₂—CH(R))ₙ—OH and —(O—CH₂—CH(R))ₙ—H whereby R is independently selected from: hydrogen, alkyl, aryl, halogen and n is from 1 to 250

Unless otherwise specified the following are more preferred group restrictions that may be applied to groups found within compounds disclosed herein:

alkyl: linear and branched C1-C6-alkyl,

long-chain alkyl: linear and branched C5-C10 alkyl, preferably linear C6-C8 alkyl

alkenyl: C3-C6-alkenyl,

cycloalkyl: C6-C8-cycloalkyl,

alkoxy: C1-C4-alkoxy, long-chain alkoxy: linear and branched C5-C10 alkoxy, preferably linear C6-C8 alkoxy

alkylene: selected from the group consisting of: methylene; 1,2-ethylene; 1,3-propylene; butan-2-ol-1,4-diyl; 1,4-butylene; cyclohexane-1,1-diyl; cyclohexan-1,2-diyl; cyclohexan-1,4-diyl; cyclopentane-1,1-diyl; and cyclopentan-1,2-diyl,

aryl: selected from group consisting of: phenyl; biphenyl; naphthalenyl; anthracenyl; and phenanthrenyl,

arylene: selected from the group consisting of: 1,2-phenylene; 1,3-phenylene; 1,4-phenylene; 1,2-naphtalenylene; 1,4-naphtalenylene; 2,3-naphtalenylene and 1-hydroxy-2,6-phenylene,

heteroaryl: selected from the group consisting of:

pyridinyl; pyrimidinyl; quinolinyl; pyrazolyl; triazolyl; isoquinolinyl; imidazolyl; and oxazolidinyl, wherein the heteroaryl may be connected to the compound via any atom in the ring of the selected heteroaryl, heteroarylene: selected from the group consisting of: pyridin 2,3-diyl; pyridin-2,4-diyl; pyridin-2,6-diyl; pyridin-3,5-diyl; quinolin-2,3-diyl; quinolin-2,4-diyl; isoquinolin-1,3-diyl; isoquinolin-1,4-diyl; pyrazol-3,5-diyl; and imidazole-2,4-diyl,

heterocycloalkyl: selected from the group consisting of:

pyrrolidinyl; morpholinyl; piperidinyl; piperidinyl; 1,4 piperazinyl; tetrahydrofuranyl; 1,4,7-triazacyclononanyl; 1,4,8,11-tetraazacyclotetradecanyl; 1,4,7,10,13-pentaazacyclopentadecanyl; 1,4,7,10-tetraazacyclododecanyl; and piperazinyl, wherein the heterocycloalkyl may be connected to the compound via any atom in the ring of the selected heterocycloalkyl, heterocycloalkylene: selected from the group consisting of:

piperidin-2,6-ylene; piperidin-4,4-ylidene; 1,4-piperazin-1,4-ylene; 1,4-piperazin-2,3-ylene; 1,4-piperazin-2,6-ylene; tetrahydrothiophen-2,5-ylene; tetrahydrothiophen-3,4-ylene; tetrahydrofuran-2,5-ylene; tetrahydrofuran-3,4-ylene; pyrrolidin-2,5-ylene; pyrrolidin-2,2-ylidene; 1,4,7-triazacyclonon-1,4-ylene; 1,4,7-triazacyclonon-2,3-ylene; 1,4,7-triazacyclonon-2,2-ylidene; 1,4,8,11-tetraazacyclotetradec-1,4-ylene; 1,4,8,11-tetraazacyclotetradec-1,8-ylene; 1,4,8,11-tetraazacyclotetradec-2,3-ylene; 1,4,8,11-tetraazacyclotetradec-2,2-ylidene; 1,4,7,10-tetraazacyclododec-1,4-ylene; 1,4,7,10-tetraazacyclododec-1,7-ylene; 1,4,7,10-tetraazacyclododec-2,3-ylene; 1,4,7,10-tetraazacyclododec-2,2-ylidene; 1,4,7,10,13-pentaazacyclopentadec-1,4-ylene; 1,4,7,10,13-pentaazacyclopentadec-1,7-ylene; 1,4-diaza-7-thia-cyclonon-1,4 ylene; 1,4-diaza-7-thia-cyclonon-2,3-ylene; 1,4-diaza-7-thia cyclonon-2,2-ylidene; 1,4-diaza-7-oxa-cyclonon-1,4-ylene; 1,4 diaza-7-oxa-cyclonon-2,3-ylene; 1,4-diaza-7-oxa-cyclonon-2,2-ylidene; 1,4-dioxan-2,6-ylene; 1,4-dioxan-2,2-ylidene; tetrahydropyran-2,6-ylene; tetrahydropyran-2,5-ylene; and tetrahydropyran-2,2-ylidene, a —C1-C6-alkyl-heterocycloalky, wherein the heterocycloalkyl of the -Cl- C6-heterocycloalkyl is selected from the group consisting of: piperidinyl; 1,4-piperazinyl; tetrahydrofuranyl; 1,4,7-triazacyclononanyl; 1,4,8,11-tetraazacyclotetradecanyl; 1,4,7,10,13-pentaazacyclopentadecanyl; 1,4,7,10-tetraazacyclododecanyl; and pyrrolidinyl, wherein the heterocycloalkyl may be connected to the —C1-C6-alkyl via any atom in the ring of the selected heterocycloalkyl,

amine: the group —N (R) 2, wherein each R is independently selected from: hydrogen; C1-C6-alkyl; and benzyl,

halogen: selected from the group consisting of: F and Cl,

sulphonate: the group —S(O)₂OR, wherein R is selected from: hydrogen; C1-C6-alkyl; Na; K; Mg; and Ca,

sulphate: the group —OS(O)₂OR, wherein R is selected from: hydrogen; C12-C6-alkyl; Na; K; Mg; and Ca,

sulphone: the group —S(O)₂R, wherein R is selected from: hydrogen; C1-C6-alkyl; benzyl and amine selected from the group: —NR′2, wherein each R′ is independently selected from:

hydrogen; C1-C6-alkyl; and benzyl,

carboxylate derivative: the group —C(O)OR, wherein R is selected from hydrogen; Na; K; Mg; Ca; C1-C6-alkyl; and benzyl, carbonyl derivative: the group: —C(O)R, wherein R is selected from: hydrogen; C1-C6-alkyl; benzyl and amine selected from the group: —NR′2, wherein each R′ is independently selected from: hydrogen; C1-C6-alkyl; and benzyl,

phosphonate: the group —P(O) (OR)₂, wherein each R is independently selected from: hydrogen; C1-C6-alkyl; benzyl; Na; K; Mg; and Ca,

phosphate: the group —OP(O) (OR)₂, wherein each R is independently selected from: hydrogen; C1-C6-alkyl; benzyl; Na; K; Mg; and Ca,

phosphine: the group —P(R)₂, wherein each R is independently selected from: hydrogen; C1-C6-alkyl; and benzyl,

phosphine oxide: the group —P(O)R₂, wherein R is independently selected from: hydrogen; C1-C6-alkyl; benzyl and amine selected from the group: —NR′2, wherein each R′ is independently selected from: hydrogen; C1-C6-alkyl; and benzyl.

polyether: chosen from the group comprising —(O—CH₂—CH(R))ₙ—OH and —(O—CH₂—CH(R))ₙ—H whereby R is independently selected from: hydrogen, methyl, halogen and n is from 5 to 50, preferably 10 to 25.

M, Mₙ (n being an integer) : Metals (either charged or uncharged), whereby two Metals Mₙ and Mₘ are independently selected from each other unless otherwise indicated.

According to an embodiment of the present invention, at least one of the organic ligand molecule(s) has the following structure II

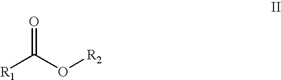

whereby R₁, and/or R₂ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

According to an embodiment of the present invention, at least one of the organic ligand molecule(s) has the following structure III

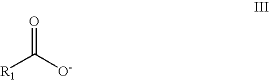

whereby R₁ is selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

According to an embodiment of the present invention, at least one of the organic ligand molecule(s) has the following structure IV

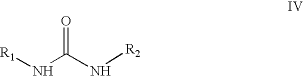

whereby R₁, and/or R₂ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

According to an embodiment of the present invention, at least one of the organic ligand molecule(s) has the following structure V

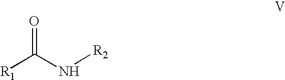

whereby R₁, and/or R₂ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

According to an embodiment of the present invention, at least one of the organic ligand molecule(s) has the following structure VI

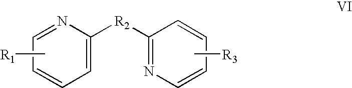

wherein R₂ is selected out of a group comprising single bond, methyl, alkyl, methylaryl, aryl, heteroaryl, methylheteroaryl, alkenyl, vinyl, alkinyl, methylalkinyl, ketoaryl, methylketoaryl, keto, ketoheteroaryl, methylketoheteroaryl, ketoalkenyl, methylketoalkenyl, ketoalkinyl, methylketoalkenyl, halogenmethyl, halogenmethyl aryl, arylene, halogenaryl, halogenalkyl, halogenheteroaryl, halogenmethylheteroaryl, halogenalkenyl, halogenvinyl, halogenalkinyl, halogenmethylalkinyl, halogenketoaryl, halogenmethylketoaryl, halogenketo, halogenketoheteroaryl, halogenmethylketoheteroaryl, halogenketoalkenyl, halogenmethylketoalkenyl, halogenketoalkinyl, halogenmethylketoalkenyl,

and wherein R₁ and/or R₃ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

It should be noted that the way of indication and/or notation for R₁ and R₃ does not mean or intend that there is only one substituted residue in each of the aromatic rings; rather the formula is to be read as if all possible substitutions (from mono- di- to quinquies substitution) were meant by this notation. This also goes for all further structures mentioned in this application.

According to an embodiment of the present invention, at least one of the organic ligand molecule(s) has the following structure VII

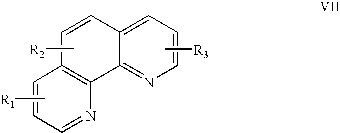

wherein R₁, R₂ and/or R₃ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

According to an embodiment of the present invention, at least one of the organic ligand molecule(s) has the following structure VIII:

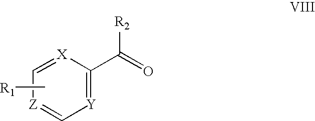

wherein R₁ and/or R₂ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether and X, Y and Z are independently selected out of a group comprising C, N, O, S.

According to an embodiment of the present invention, at least one of the organic ligand molecule(s) has the following structure IX:

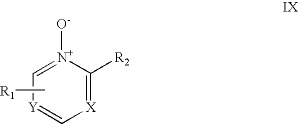

wherein R₁ and/or R₂ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether; and

X and Y are independently selected out of a group comprising C, N, O, S.

According to an embodiment of the present invention, at least one of the organic ligand molecule(s) has the following structure X:

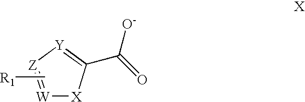

wherein R₁ is selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

and W, X, Y and Z are independently selected out of a group comprising C, N, O, S.

According to an embodiment of the present invention, at least one of the organic ligand molecule(s) has the following structure XI:

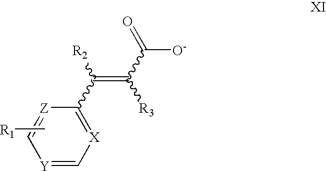

wherein R₁, R₂ and/or R₃ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

and X, Y and Z are independently selected out of a group comprising C, N, O, S.

It should be noted that the bonds

[symbol]

are supposed to indicate that all possible cis/trans isomers are covered by the structure XI.

According to an embodiment of the present invention, at least one of the organic ligand molecule(s) has the following structure XII

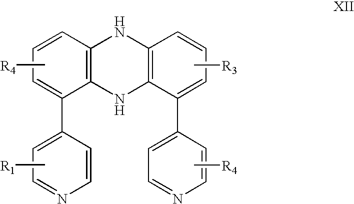

wherein R₁, R₂, R₃ and/or R₄ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

According to an embodiment of the present invention, at least one of the organic ligand molecule(s) has the following structure XIII

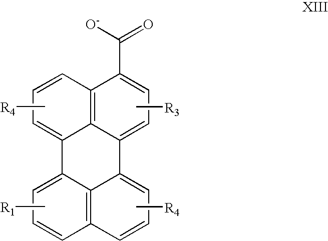

wherein R₁, R₂, R₃ and/or R₄ are independently selected out of a group comprising hydrogen, hydroxyl, halogen, pseudohalogen, formyl, carboxy- and/or carbonyl derivatives, alkyl, long-chain alkyl, alkoxy, long-chain alkoxy, cycloalkyl, halogenalkyl, aryl, arylene, halogenaryl, heteroaryl, heteroarylene, heterocycloalkylene, heterocycloalkyl, halogenheteroaryl, alkenyl, halogenalkenyl, alkinyl, halogenalkinyl, keto, ketoaryl, halogenketoaryl, ketoheteroaryl, ketoalkyl, halogenketoalkyl, ketoalkenyl, halogenketoalkenyl, phosphoalkyl, phosphonate, phosphate, phosphine, phosphine oxide, phosphoryl, phosphoaryl, sulphonyl, sulphoalkyl, sulphoarenyl, sulphonate, sulphate, sulphone, amine, polyether.

The present invention furthermore relates to light emitting device, especially a LED comprising a luminescent material as described above.

The present invention furthermore relates to a use of a luminescent material as described above in biological applications, preferably bio- and/or immunoassays.

Surprisingly it has been found that a luminescent material as described within the present invention may be used as “labelling” substance in biochemical applications, e.g. in bio- and/or immunoassays.

The luminescent material can according to one application of the present invention be used as a marker to label certain biochemical molecules or according to another application of the present invention be used as a marker to label cell moieties.

The labelling may according to one application of the present invention occur via a linker molecule or according to one application of the present invention by physical adhesion.

A luminescent material and/or a light emitting device according to the present invention may be of use in a broad variety of systems and/or applications, amongst them one or more of the following:
Office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
indicator sign systems, and
decorative lighting systems
portable systems
automotive applications
green house lighting systems

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, characteristics and advantages of the object of the invention are disclosed in the subclaims, the figures and the following description of the respective figures and examples, which—in an exemplary fashion—show several embodiments of an Eu-comprising material use in a light emitting device according to the invention as well as an LED according to embodiments of the present invention.

FIG. 1 shows an XRD spectrum of a (Y,Gd)-containing nanoparticle material according to a first example of the present invention

FIG. 2 shows an excitation and an emission spectrum of the material of FIG. 1

FIG. 3 shows an excitation and an emission spectrum of a luminescent material according to a first embodiment of the present invention employing the (Y,Gd)-containing nanoparticle material of FIGS. 1 and 2

### EXAMPLE I

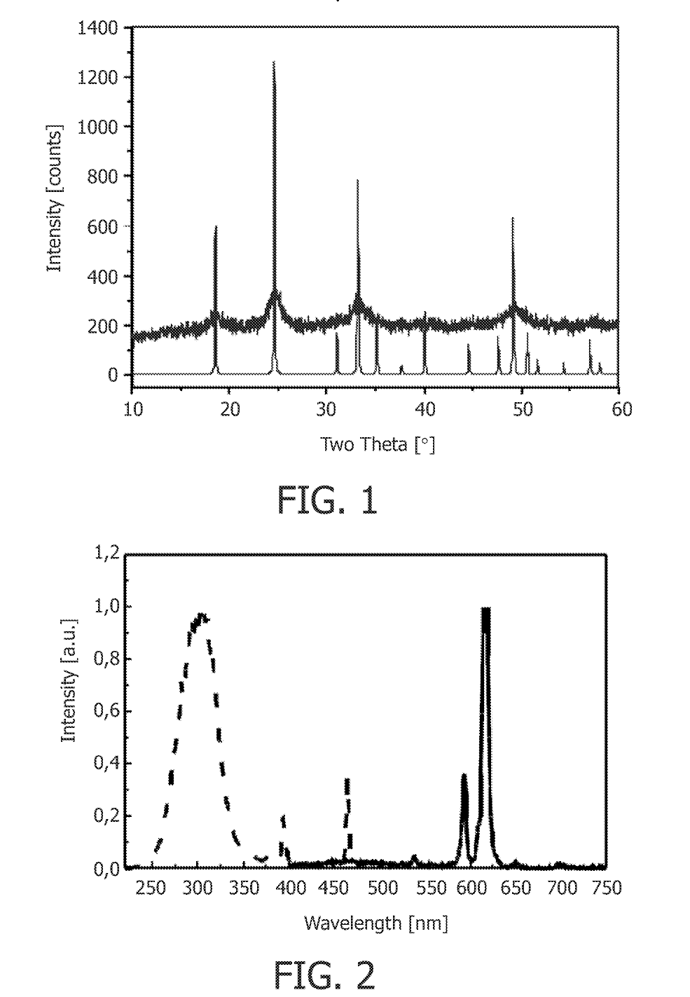

FIGS. 1 to 3 refer to a (Y,Gd)-containing nanoparticle material and a luminescent material using this (Y,Gd)-containing nanoparticle material. The (Y,Gd)-containing nanoparticle material used within this example is GdVO₄:Eu (5%) which was made as follows

GdCl₃ (9.5 mmol) and EuCl₃ (0.5 mmol) were dissolved in 375 ml H₂O. NaVO₄ was subsequently added in 50 ml at ambient temperature, resulting in a “milky” solution which was heated to 100° C. for about 30 minutes. The resulting precipitate was collected, washed with water and with acetone and dried at 60° C. The yield was 2,5162 g.

FIG. 1 shows an XRD spectra of the GdVO₄:Eu material. It can be seen that the d₅₀ size of the particles is 10 nm.

FIG. 2 shows an excitation (dotted line) and an emission spectrum of the material of FIG. 1. The excitation spectrum (dotted line) shows a maximum somewhat around 290-300 nm, the emission spectrum has several sharp bands, the most prominent band is at 625 nm.

The GdVO₄:Eu material was then suspended in Ethanol and a solution of 2-Thenoyltrifluoracetylacetone (see structure) and NaOMe in Ethanol was added. The suspension was heated at reflux for one hour. After cooling, the resulting precitipate was collected and washed twice with ethanol. The yield was 0,1075 g light-yellow powder.

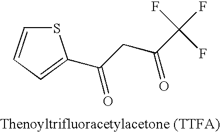

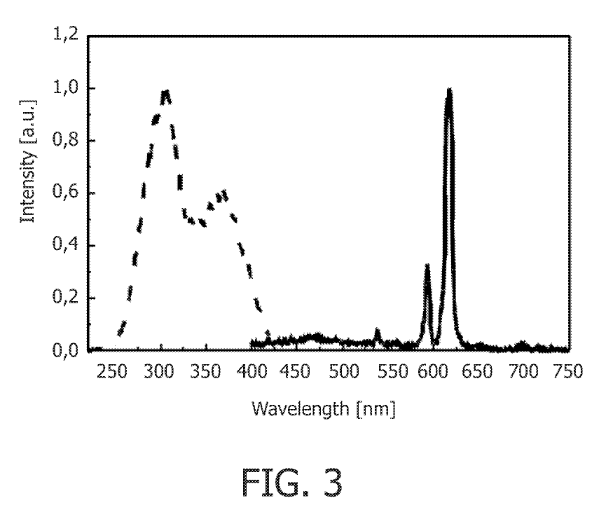

FIG. 3 shows an excitation spectrum (dotted line) and an emission spectrum of the GdVO₄:Eu/TTFA material.

From the spectra it can be clearly seen that the luminescent material shows a further excitation band in the area around 380 nm. This additional excitation band is due to the presence of the organic ligand, which absorbs in the near UV and transfers the absorbed energy to the Eu³⁺ centre.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. Luminescent material for a light emitting device comprising an (Y,Gd)-containing nanoparticle material linked to at least one organic ligand molecule.

2. Luminescent material of claim 1, whereby the size of the (Y,Gd)-containing nanoparticle material is ≧2 nm to ≦100 nm.

3. The luminescent material of claim 1, whereby (Y,Gd)-containing nanoparticle material is doped with at least one dopant material selected out of the group La, Ce, Pr, Nd, Pm, Sm, Eu, Gd, Tb, Dy, Ho, Er, Tm, Yb, Lu.

4. The luminescent material of claim 1 whereby the dotation level of the dopant material in the (Y,Gd)-containing nanoparticle material is ≧0,5% to ≦50%.

5. The luminescent material of claim 1 whereby the at least one organic ligand molecule is a multidentate and/or chelate material.

6. The luminescent material of claim 1 whereby the at least one organic ligand molecule is a N and/or O-donor material.

7. The luminescent material of claim 1 whereby the at least one organic ligand molecule absorbs in the region of ≧300 nm to ≦500 nm and/or has a triplet state which is ≧3000 cm⁻¹ to ≦13000 cm⁻¹ above the light emitting state of the light emitting material(s) in the (Y,Gd)-containing nanoparticle material.

8. The luminescent material of claim 1 whereby ratio of organic ligand molecule(s) to the light emitting material(s) in the (Y,Gd)-containing nanoparticle material is ≦0.01:1 to ≧0.9:1.

9. A light emitting device, especially a LED comprising a luminescent material according to claim 1.

10. A system comprising a luminescent material according to claim 1, the system being used in one or more of the following applications:
Office lighting systems
household application systems
shop lighting systems,
home lighting systems,
accent lighting systems,
spot lighting systems,
theater lighting systems,
fiber-optics application systems,
projection systems,
self-lit display systems,
pixelated display systems,
segmented display systems,
warning sign systems,
medical lighting application systems,
indicator sign systems, and
decorative lighting systems
portable systems
automotive applications
green house lighting systems
